(19) United States
(12) Patent Application Publication
(10) Pub. No.: US 2013/0260300 A1
(43) Pub. Date: Oct. 3, 2013

(54) DEVELOPER AND TONER CARTRIDGE

(71) Applicants: KABUSHIKI KAISHA TOSHIBA, Tokyo (JP); TOSHIBA TEC KABUSHIKI KAISHA, Tokyo (JP)

(72) Inventor: Satoshi Araki, Shizuoka-ken (JP)

(73) Assignees: TOSHIBA TEC KABUSHIKI KAISHA, Tokyo (JP); KABUSHIKI KAISHA TOSHIBA, Tokyo (JP)

(21) Appl. No.: 13/852,253

(22) Filed: Mar. 28, 2013

Related U.S. Application Data
(60) Provisional application No. 61/619,530, filed on Apr. 3, 2012.

(51) Int. Cl. G03G 9/00; G03G 15/08

(52) U.S. Cl. CPC G03G 9/09378; G03G 15/0832
USPC 430/105; 430/108.4; 399/252

(57) ABSTRACT

In accordance with the embodiment, a developer includes a toner, wherein the toner includes a binder resin, a coloring material, a crystalline polyester resin having a peak DSC melting point of higher than 90 degree Celsius but lower than 110 degree Celsius, a toner core particle including an ester wax having a liner alky having 15-48 carbons, containing an ester compound of the carbon number of which represents the maximum strength in mass spectrometer content of more than 20 weight percent but smaller than 45 percent of the total weight of all of the ester wax and containing a silica particle having a volume average particle size of smaller than 85 nm combined by a sol-gel method, wherein the toner with the silica particle content of 0.2-2.0 weight percent.

### CROSS-REFERENCE TO RELATED APPLICATIONS

This application is based upon and claims the benefit of priority from U.S. Provisional Application No. 61/619,530 filed on Apr. 3, 2012; the entire contents of which are incorporated herein by reference

### FIELD

Embodiments described herein relate to a developer and a toner cartridge.

### BACKGROUND

In recent years, more and more toners area are prepared with an ester wax with super resistance to high-temperature offset and a crystalline polyester with super resistance to low-temperature offset so as to achieve a broad non-offset area. However, in the case of the use of an ester WAX having a long linear, the ester WAX cannot be finely dispersed in the toner, leading to an increased dispersion diameter of the WAX in the toner and further to a deteriorated resistance to low-temperature offset.

The conventional mainstream AC-DC laser printer is high in development efficiency and restricted in toner scattering and fogging margin in a high-temperature high-humidity environment but suffers image quality problems related to toner dust and sharpness. In recent years, a DC development method excellent in image quality becomes more and more popular. However, if the toner used in an AC development method is applied to the DC development method, the development efficiency will be reduced, thus, in order to guarantee the development amount in a low-temperature low-humidity environment, the total charge quantity needs decreasing, moreover, in the case of the use of a crystalline polyester resin, the charging property in a high-temperature high-humidity environment is weakened, thus, the fogging and the toner scattering in a high-temperature high-humidity environment becomes big problems.

### BRIEF DESCRIPTION OF THE DRAWINGS

FIG. 1 is a schematic diagram showing an example of an image forming apparatus to which the developer and the toner cartridge involved in embodiments described herein can be applied.

### DETAILED DESCRIPTION

In accordance with an embodiment, a developer including a toner, wherein

the toner includes:

a binder resin;

a coloring material;

a crystalline polyester resin having a peak DSC melting point of higher than 90 degree Celsius but lower than 110 degree Celsius;

a toner core particle including an ester wax having a liner alky having 15-48 carbons and containing an ester compound of the carbon number of which represents the maximum strength in mass spectrometer content of more than 20 weight percent but smaller than 45 percent of the total weight of all of the ester wax; and

a silica particle having a volume average particle size of smaller than 85 nm combined by a sol-gel method and added on the surface of the toner core particles as an additive, wherein

the toner with the silica particle content of 0.2-2.0 weight percent.

The developer involved in the embodiment comprises: a binder resin, a coloring material, a crystalline polyester resin, toner core particles containing an ester wax and an additive added on the surface of the toner core particles.

The crystalline polyester resin used in the embodiment has a peak melting point of higher than 90 degree Celsius but lower than 110 degree Celsius as in differential scanning calorimetry (DSC).

The ester wax has a linear alkyl group having 15-48 carbons and contains more than 20% but smaller than 45% by weight of an ester compound the carbon number of which represents the maximum strength in a mass spectrometry.

The silica particle combined by the sol-gel method used as an additive has a volume average particle size of smaller than 85 nm and accounts for 0.2-2.0% by weight of the total weight of the developer.

In addition, the toner is housed in the toner cartridge involved in the embodiment.

In accordance with the embodiment, in a laser printer adopting a high image quality DC development method, the toner refers to a tone prepared by combining an ester WAX containing a WAX that is well dispersed in the toner and a crystalline polyester resin with silica particle having a volume average particle size of smaller than 85 nm combined by the sol-gel method and the rate of charge is good, so the toner gains both a low-temperature fixation property and a long life compared to the conventional toner,

In the ester wax used in the embodiment, as the ester wax has a linear alkyl group having 15-48 carbons and contains more than 20% but smaller than 45% by weight of an ester compound the carbon number of which represents the maximum strength in a mass spectrometry, the ester wax is well dispersed in the developer. The developer prepared with the combination of the ester wax having excellent dispersion property and the crystalline polyester resin can be stored well and achieves a low-temperature fixation property. In addition, as the silica particle having a volume average particle size of smaller than 85 nm combined by the sol-gel method is used in combination with the crystalline polyester resin having a weak charging property in a high-temperature high-humidity environment and the developer is used in a DC development method, the rising of charging can be full realized even the toner is reduced in charge quantity, which prohibits the scattering and the fogging of the toner while enabling the toner to be stored well. Thus, by using the toner involved in the embodiment, a high-quality image can be formed in the DC development method.

Embodiments are described below.

The binder resin used in the embodiment may be an amorphous polyester resin.

As to the polyester resin component, for example, in Japanese Unexamined Patent Application Publication No. 7-175260, the polyester resin is prepared with the exemplary compounds by ester reacting and polycondensing a dicarboxylic acid component with a diol component.

Raw monomers of the polyester may be an alcohol component having a valence of above 2 and a carboxylic acid component having a valence of above 2 such as carboxylic acid, carboxylic acid anhydride and carboxylic acid ester.

A bivalent alcohol component may be, for example, alkylene oxide adducts of bisphenol A such as polyoxyethylene polyoxypropylene (2.2)-2,2-bis(4-hydroxyphenyl) propane, polyoxyethylene polyoxypropylene (3.3)-2,2-bis(4-hydroxyphenyl) propane, polyoxyethylene polyoxypropylene (2.0)-2,2-bis(4-hydroxyphenyl) propane, polyoxyethylene polyoxypropylene (2.0)-Polyoxyethylene (2.0)-2,2-bis(4-hydroxyphenyl) propane and polyoxyethylene polyoxypropylene (6)-2,2-bis(4-hydroxyphenyl) propane, ethylene glycol, diethylene glycol, triethylene glycol, 1,2-propylene glycol, 1,3-propylene glycol, 1,4-butanediol, neopentyl glycol, 1,4-pentane diol, 1,5-pentane diol, 1,6-hexane diol, 1,4-cyclohexanedimethanol, dipropylene glycol, polyethylene glycol, polypropylene glycol, polytetramethylene glycol, bisphenol A and hydrogenated bisphenol A.

Preferably, the bivalent alcohol component is the oxide adduct of bisphenol A-Alkylene (having 2 or 3 carbons) (average number of added moles is 1-10), ethylene glycol, propylene glycol, 1,6-ethyl hexanediol, Bisphenol A and hydrogenated bisphenol A.

An alcohol component having a valence of above 3 may be, for example, sorbitol, 1,2,3,6-hexane tetrol, 1,4-sorbitan, pentaerythritol, dipentaerythritol, tripentaerythrito, 1,2,4-butane triol, 1,2,5-pentane trio, glycerol, 2-methyl propane triol, 2 methyl 1,2,4-butanetriol, trimethylolethane, trimethylolpropane and 1,3,5-trihydroxy methyl benzene.

Preferably, the alcohol component having a valence of above 3 is sorbitol, 1,4-Sorbitan, pentaerythritol, glycerol and trimethylolpropane.

In the embodiment, the bivalent alcohols and the alcohols having a valence of above 3 may be used separately or in a combination manner, especially, bisphenol A-alkylene (having 2 or 3 carbons) oxide adduct (average number of added moles is 1-10) may be used as a primary component.

The bivalent carboxylic acid may be, for example, maleic acid, fumaric acid, citraconic acid, itaconic acid, glutaconic acid, phthalic acid, isophthalic acid, terephthalic acid, cyclohexanedicarboxylic acid, succinic acid, adipic acid, sebacic acid, azelaic acid, malonic acid, or an alkenyl succinic acid such as n-dodecenyl succinic acid, an alkyl succinic acid such as n-dodecyl succinic acid, or the anhydrides and lower alkyl esters thereof.

Preferably, the bivalent carboxylic acid component is maleic acid, fumaric acid, terephthalic acid and succinic acid replaced by alkenyl group having 2-20 carbons.

The carboxylic acid having a valence of above 3 may be, for example, 1,2,4-benzenetri carboxylic acid, 2,5,7-naphthalene tri carboxylic acid, 1,2,4-naphthalene tricarboxylic acid, 1,2,4-butane tricarboxylic acid, 1,2,5-hexane tricarboxylic acid, 1,3-dicarboxylic-2-methyl-2-propane methylene carboxylate, 1,2,4-cyclohexane tricarboxylic acid, tetra (methylene carboxyl) methane, 1,2,7,8-octane tetra carboxylic acid, pyromellitic acid, enporu tripolymer acid, and acid anhydrides and lower Alkyl esters thereof.

Preferably, the carboxylic acid having a valence of above 3 is 1,2,4-benzenetri carboxylic acid) (trimellitic acid) and anhydrides alkyl (having 1-12 carbons) esters thereof.

In accordance with the embodiment, the bivalent carboxylic acids and the carboxylic acids having a valence of above 3 may be used separately or in a combination manner. Especially, the bivalent carboxylic acid component is fumaric acid, terephthalic acid and succinic acid replaced by an alkenyl group having 2-20 carbons, and 1,2,4-benzenetri carboxylic acid) (trimellitic acid) and anhydrides, alkyl (having 1-12 carbons) esters thereof are used as primary component of the carboxylic acid having a valence of above.

When polymerizing the monomer raw material polyester, in order to promote the reaction, a common catalyst such as dibutyltin Oxide, titanium compound, dialkoxy tin (II), oxide tin (II), fatty acid tin (II), dioctanoate (II) and distearate tin (II) may be used properly.

The ester wax used in the embodiment is a wax synthesized by a long-chain alkyl carboxylic acid and a long-chain alkyl alcohol. The addition amount of the wax, to which no specific limitation is given, is preferably 3-10 parts by weight with respect to 100 parts by weight of the binder resin. If the addition amount is below 3 parts, then low-temperature fixation property is unreachable, on the other hand, if the addition amount is above 10 parts, storage quality is unreachable.

The ester wax used in the embodiment is the following ester wax: an ester wax is an ester wax having a liner alky having 15-48 carbons and containing an ester compound of the carbon number of which represents the maximum strength in mass spectrometer content of more than 20 weight percent but smaller than 45 percent of the total weight of all of the ester wax.

If the carbon number is smaller than 15 and the carbon number representing the maximum strength is above 45, there is a trend that the storability cannot be achieved. In addition, if a linear alkyl group having more than 48 carbons is contained and the carbon number representing the maximum strength is above 45, there is a trend that lower-temperature fixation property cannot be achieved. The carbon number of the ester compound representing the maximum strength in mass spectrometry is 38-45.

As the acid component of the crystalline polyester resin used in the embodiment may be: adipic acid, oxalic acid, malonic acid, maleic acid, fumaric acid, citraconic acid, itaconic acid, glutaconic acid, succinic acid, phthalic acid, isophthalic acid, terephthalic acid, sebacic acid, azelaic acid, n-dodecenyl succinic acid, n-dodecyl succinic acid, cyclohexanedicarboxylic acid, trimellitic acid, pyromellitic acid and mineral acids and alkyl (having 1-3 carbons) esters thereof, and is preferably fumaric acid. As the alcohol component may be ethylene glycol, 1,2-propylene glycol, 1,3-propylene glycol, 1,4-butanediol, 1,5-pentane diol, 1,6-hexane diol, neopentyl glycol, 1,4-Pentane diol, polyoxypropylene, polyoxyethylene, glycerin, pentaerythritol and trimethylolpropane, and is preferably 1,4-butanediol and 1,6-Hexane diol. In addition, the crystalline polyester resin used in the embodiment has a peak melting point of higher than 90 degree Celsius but lower than 110 degree Celsius as measured by differential scanning calorimetry (DSC). If the peak melting point of the crystalline polyester resin is below 90 degree Celsius, then the storability cannot be achieved. On the other hand, if the peak melting point of the crystalline polyester resin is above 110 degree Celsius, the low-temperature fixation property of the toner cannot be achieved. The addition amount of the crystalline polyester may be 3-10 parts by weight with respect to 100 parts by weight of the binder resin. If the addition amount is below 3 parts, then low-temperature fixation property is unreachable, moreover, on the other hand, if the addition amount is above 10 parts, then there is a trend that the storability cannot be achieved.

In addition, the total content of the ester wax and the crystalline polyester resin may be 6-20 parts by weight with respect to 100 parts by weight of the binder resin. If the total content is below 6 parts by weight, then low-temperature fixation property is unreachable, on the other hand, if the total content is above 20 parts by weight, then there is a trend that the storability cannot be achieved.

Further, the crystalline polyester resin here refers to a material having a softening point and a melting temperature the ratio of which is 0.9 to 1.1.

The coloring agent used in the embodiment may be carbon block, organic or inorganic pigment or dye for use in color toner. Although no specific limitation is given to the coloring agent used in the embodiment, the carbon block is preferably acetylene black, furnace black, thermal black, channel black and Ketj en black. Further, as the dye, for example, fast Yellow G, benzidine yellow, india fast orange, irganox gin red, carmine FB, permanent bordeaux FRR, pigment orange R, lithol red 2G, lake red C, rhodamine FB, rhodamine B Rake, phthalocyanine blue, pigment blue, brilliant green B, phthalocyanine green and luinacridone, which may be used separately or in a combination manner. The addition amount of the coloring agent may be 4-15 parts by weight with respect to 100 parts by weight of the binder resin.

AS the charge control agent used in the embodiment may be a metal-containing azo compound, the metal element is, for example, iron, cobalt, complexes of chromium, complex salts or mixtures thereof. In addition, the charge control agent may further be a mental-containing salicylic acid derivative compound or a compound resulting from the hydrophobization of a metallic oxide, the metal element may be, for example, zirconium, zinc, chromium, complex of boron, complex salts or mixtures thereof. The charge control agent may further be an inclusion compound of a polysaccharide containing aluminum and magnesium.

The addition amount of the charge control agent may be 0.5-3 parts by weight with respect to 100 parts by weight of the binder resin. If the addition amount is below 0.5 part by weight, then there is a trend that the environmental fluctuation gets worse, on the other hand, if the addition amount is above 3 parts by weight, then there is a trend that low-temperature fixation is deteriorated.

The unit (e.g. mixing machine) for mixing and dispersing raw materials may be a Henschel mixer (produced by Mitsui Mining & Smelting CO., LTD), a Super mixer (produced by Kawata Co. LTD), a Ribocone (produced by Ohkawara Kakohki CO., LTD), a Nauta mixer/turbulator riser/cyclomix (produced by Hosokawa Micron Corporation), a Spiral pin mixer (produced by Pacific Machine Industry Corporation) and a Loedige mixer (produced by MATSUBO Corporation); a kneader may be a KRC blade kneader produced by KURIMOTO, LTD), a buss kneader (produced by Buss Company), a TEM mold extruder (produced by Toshiba Machine Company), a TEX two-screw kneader (produced by Japan Steel Works, LTD); a PCM kneader (produced by Ikegai Corp), a Triple Roll Mill/mixing roll mill/blade kneader (produced by Furukawa Electric Power Systems CO., LTD), a kneadex (produced by Mitsui Mining & Smelting CO., LTD), an MS type pressurized kneader/Nidaruder) (produced by Moriyama Corporation, LTD); and a Banbury mixer (produced by Kobe Steel, LTD).

Further, a unit for coarsely pulverizing the mixture is, for example, a hammer mill, a cutter mill, a jet mill, a roller mill and a ball mill. In addition, a unit for finely pulverizing the coarsely pulverized material may be, for example, a counter jet mill, a micron jet, a yinomayiza (produced by Hosokawa Micron Corporation), an IDS mill, a PJM jet pulverizer (produced by Japan Pneumatic Industry Corporation), a cross jet mill produced by Ikegai Corp), a ulmax (produced by Nisso Shoji CO., LTD); an SK jet aux mill (produced by Seishin Corporation); a Cryptron (produced by Kawasaki Heavy Industries, Ltd), and a turbomill (produced by Turbo Industries, Ltd).

A classifier for classifying the finely pulverized material may be a high-efficiency precision air classifier, a dry air classifier, a forced turbo classifier (produced by Seishin

Corporation); a turbo air classifier (produced by Nissin Engineering Corporation); a Micron separator, micro-grinder (ATP), TSP separator (produced by Hosokawa Micron Corporation); multi-product air classifier (elbow jet) (produced by Nittetsu Mining Co Ltd), a dispersion separator (produced by Japan Pneumatic Industry Corporation); A YM micro cut (produced by YASKAWA Electric Corporation).

In the embodiment, in order to stabilize the fluidity or charging property and storability, a micro-particle additive is added on the surface of the toner core particle prepared by the procedures above.

In the embodiment, more than 0.2% but smaller than 2% by weight of silica particle having a volume average particle size φ of smaller than 85 nm (measured by a Dynamic light scattering method) combined by a sol-gel method can be added into the toner mother particle as such an additive. The silica particle combined by the sol-gel method may be, for example, TG-C413 (having a volume average particle size of 50 nm), TG-C443 (having a volume average particle size of 50 nm), TG-C390 (having a volume average particle size of 65 nm) and TG-C243 (having a volume average particle size of 85 nm) produced by Cabot Corporation. The silica particle combined by the sol-gel method can prohibit the fogging or scattering of the toner in a high-temperature high-humidity environment and become a form a circle easily than fumed melted silica. Thus, it is considered that the surface of the toner rubs against the surface of a carrier easily. In addition, if the volume average particle size of the silica particle combined by the sol-gel method is above 85 nm, then fluidity is significantly degraded, making the storability cannot achieved. Further, the silica particle combined by the sol-gel method may have a volume average particle size of 50-85 nm. If the volume average particle size of the silica particle is smaller than 50 nm, then the frictional force between the surfaces of the toner and the carrier is reduced, causing a trend that the charging rising cannot be fully guaranteed and the scattering of the toner gets worse.

Further, other kinds of silica may be used together, such as melted silica particle, titanium oxide, alumina, strontium titanate, tin oxide and other inorganic fine particle oxides having a diameter of below 1 μm.

From the viewpoint of improving environmental safety, the inorganic fine particle oxides may be subjected to a surface processing using a hydrophobic agent. In addition to the inorganic fine particle oxides above, resin fine particles having a diameter of below 1 μm may be added as well.

For example, the melted silica particle and the titanium oxide which can be used as an additive may have a volume average particle size of 7-150 nm. If the volume average particle size of the melted silica particle and the titanium oxide is smaller than 7 nm, then, there is a trend that the charge quantity rises remarkably in a low-temperature low-humidity environment and the developer cannot be stored; if the volume average particle size of the melted silica particle and the titanium oxide is greater than 150 nm, then the fluidity of the developer may get worse.

The addition amount of the melted silica particle and the titanium oxide may be determined to be 1.5-7% of the weight of the toner. If the addition amount of the melted silica particle and the titanium oxide is smaller than 1.5 part by weight, then the fluidity and the storability of the toner may get worse, and if the addition amount of the melted silica particle and the titanium oxide is greater than 7 parts by weight, then the low-temperature fixation property of the toner may get worse.

The aforementioned mixing machine is used as a unit for mixing additives.

A separator for separating particles may be Ultrasonic (produced by KOEI SANGYO CO., Ltd); an ultrasonic vibrating screen, a Gyro shifter (produced by Tokuju Corporation); a Sonic Baibura system (produced by Dalton Corporation), a Sonicator clean (produced by Sintokogio, Ltd); a turbo separator (produced by Turbo Industries, Ltd); a micro shifter (produced by Makino Industry Co., Ltd) and a circular vibrating separator.

In the embodiment, the toner may also be created using the following method:

The toner is created through the following procedures: a procedure of mixing a coarsely granulated mixture at least containing binder resin and coloring agent with an aqueous medium; a procedure of supplying the mixture liquid in a mechanical shearing manner and granulating the coarsely-granulated mixture finely; a procedure of coagulating the fine particles to form coagulated particles; and a procedure of fusing the coagulated particles together.

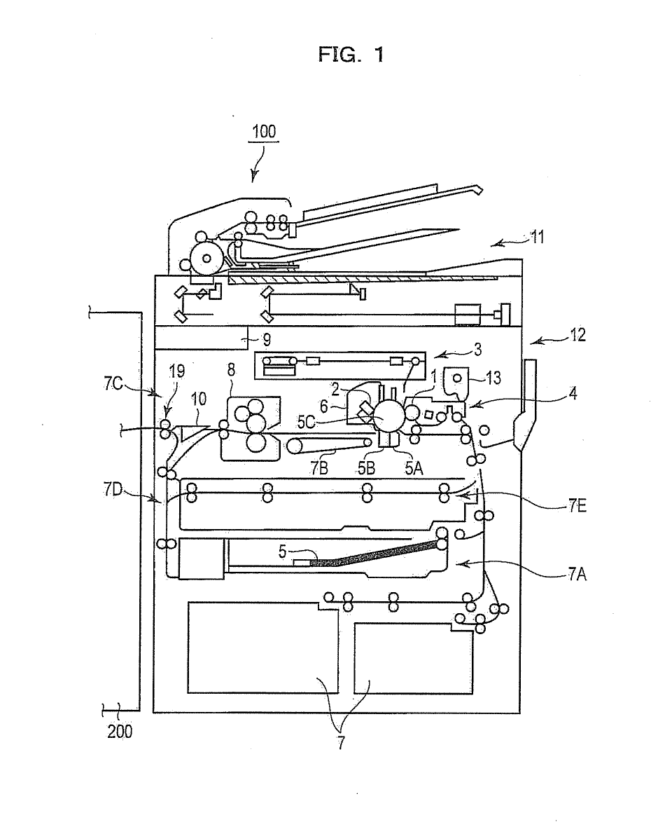

FIG. 1 is a schematic diagram showing an example of an image forming apparatus to which the developer and the toner cartridge involved in the embodiment can be applied.

As shown in FIG. 1, the image forming unit 12 of an image forming apparatus 100 has a photoconductive drum 1 in the center part thereof, a charging unit 2, an exposure unit 3, a developing unit 4, a fixing unit 5A, a charge removal unit 5B, a separation claw 5C and a cleaning unit 6 are configured around the photoconductive drum 1. A transferring unit 8 is configured at the downstream side of the charge removal unit 5B. An image forming processing is carried out using the units above substantially through the following procedures:

The charging unit 2 charges the surface of the photoconductive drum 1 uniformly. On the other hand, the original read by a reading unit 11 is converted to image data and then input to the exposure unit 3. A laser beam corresponding to the level of the image data is irradiated onto the photoconductive drum 1 using the exposure unit 3 to form an electrostatic latent image on the photoconductive drum 1. By developing the electrostatic latent image using the toner fed from the developing unit 4, a toner image is formed on the photoconductive drum 1. Further, a toner cartridge 13 is housed above the developing unit 4 detachably with respect to the apparatus 100. The toner cartridge 13 supplies a toner to the developing unit 4 using a toner supply mechanism (not shown)

The paper stored in a sheet storing unit 7 is conveyed to a transferring position (the gap between the photoconductive drum 1 and the transferring unit 5A) by a plurality of conveying rollers. The toner image is transferred onto the paper by the transferring unit 5A at the transferring position. Then, the charges on the surface are erased by the charge removal unit 5B. The paper is separated from the photoconductive drum 1 through the separation claw 5C and then conveyed by an intermediate conveying unit 78. The toner image is fixed on the paper by heating and pressurizing in the fixing unit 8, and then the fixation processing is ended. The paper is discharged from a discharging unit 7C and then output to a paper post-processing apparatus 200.

The developer left on the surface of the photoconductive drum 1 is removed using the cleaning unit 6 at the downstream side of the separation claw 5C to make preparation for the next image.

In the case of a duplex printing, the paper having a fixed toner image on the surface is reversed. The reversal of the paper is divided from the normal discharging passage by the conveying path switching plate 7D and then switched back in the reversal conveying unit 7E. After the paper is reversed, the print processing is carried out as well as simplex printing even for the back side of the paper. The paper is conveyed to the paper post-processing apparatus 200 by a discharging roller 19 configured in a discharging unit 7C. The discharging roller 19 comprises an upper roller 19a and a lower roller 19b.

The paper post-processing apparatus 200 carries out a post-processing on the paper discharged from the image forming apparatus 100. The post-processing may be, for example, sorting, stapling, or a folding and discharging operation following a saddle stitching if needed.

### EXAMPLES

Preparation of Ester Wax (A)

Add 70 parts by weight of lignoceric acid, 10 parts by weight of palmitate and 20 parts by weight of lignoceryl alcohol in four flasks in which a stirrer, a thermoelectric couple and a nitrogen guide tube are configured, conduct esterification reaction at 220 degree Celsius under a stream of nitrogen, dilute the obtained reactant in a mixed solvent, add sodium hydroxide solution, and stir the mixture for 30 min at 70 degree Celsius. Then, place the mixture still for 30 min to remove a water layer. Further, repeat the procedure of adding ion exchanged water, stirring the mixture for 30 min at 70 degree Celsius, placing the mixture still for 30 min and removing the water layer for five times, and distil the solvent of the obtained ester layer away at a reduced pressure to obtain an ester wax (A) the acid value of which is 0.1 mg KOH/g and the hydroxyl value of which is 0.5 mg KOH/g. The structural formula of the ester wax is shown in the following formula (I)

CH₃(CH₂)ₙCOO(CH₂)ₘCH₃ (n, m are constants) (1)

By changing the type and the quantity of long chain alkyl carboxylic acids as well as the type and the quantity of long chain alkyl alcohols, various ester waxes can be prepared. Especially, in order to expand distribution, a plurality of types of long chain alkyl carboxylic acids and a plurality of types of long chain alkyl alcohols are used together.

Long chain alkyl carboxylic acid component

| | |
|---|---|
| palmitic acid | (C₁₆H₃₂O₂) |
| stearic acid | (C₁₈H₃₆O₂) |
| arachidyl acid | (C₂₀H₄₀O₂) |
| behenic acid | (C₂₂H₄₄O₂) |
| lignoceric acid | (C₂₄H₄₈O₂) |

Long chain alkyl alcohol component

| | |
|---|---|
| palmitic alcohol | (C₁₆H₃₄O) |
| stearic alcohol | (C₁₈H₃₈O) |
| arachidyl alcohol | (C₂₀H₄₂O) |
| behenic alcohol | (C₂₂H₄₆O) |
| lignoceric alcohol | (C₂₄H₄₈O) |

FD/MS′JMS-T100GC′ (produced by JEOL) is used in the mass spectrometry of the obtained ester wax. The mass spectrometry is carried out in 1 mg sample (dissolved in 1 ml Chloroform) at a cathode voltage of −10 kV, a spectrum recording interval of 0.4 second in measurement mass range of m/z 10-2000, the strength of each carbon number of the ester compound is correspondingly set to be 100 to calculate the relative strength of each carbon number to confirm the maximum strength.

The carbon number of the ester wax (A) obtained in the way above is ranged from 36-48, and the ester compound having the maximum number of carbons accounts for 35.3% of the entire wax. Data of the ester wax (A) is shown in the following table 1.

Preparation of Ester Wax (B)

Add 80 parts by weight of behenic acid and 20 parts by weight of arachidyl alcohol in four flasks in which a stirrer, a thermoelectric couple and a nitrogen guide tube are configured, prepare an ester wax (B) having 38-46 carbons and is that the ester compound having the maximum number of carbons content of 46.2% of the total wax in the way the ester wax (A) is prepared. Data of the ester WAX (B) is shown in the following table 1.

Preparation of Ester Wax (C)

Add 10 parts by weight of palmitic acid, 30 parts by weight of stearic acid, 40 parts by weight of arachidyl acid, 40 parts by weight of stearic acid and 20 parts by weight of stearic alcohol in four flasks in which a stirrer, a thermoelectric couple and a nitrogen guide tube are configured, prepare an ester wax (C) having 32-48 carbons and is that the ester compound having the maximum number of carbons content of 21.9% of the total wax in the way the ester wax (A) is prepared. Data of the ester wax (C) is shown in the following table 1.

Preparation of Comparative Ester Wax (D)

In addition add 80 parts by weight of lignoceric acid and 20 parts by weight of erucate alcohol, operate as well as the adjustment of the ester wax (A), prepare a comparative ester (D) having 38-46 carbons and is that the ester compound having the maximum number of carbons content of 46.2% of the total wax in the way the ester wax (A) is prepared. Data of the ester wax (D) is shown in the following table 1.

Preparation of Comparative Ester Wax (E)

In addition add 10 parts by weight of palmitic acid, 30 parts by weight of stearic acid, 40 parts by weight of behenic acid, 10 parts by weight of stearic alcohol and 10 parts by weight of Arachidyl alcohol, operate as well as the adjustment of the ester wax (A), prepare a comparative ester (E) having 34-48 carbons and is that the ester compound having the maximum number of carbons content of 19.1% of the total wax in the way the ester wax (A) is prepared. Data of the comparative ester wax (E) is shown in the following table 1.

Preparation of Comparative Ester Wax (F)

In addition add 10 parts by weight of palmitic acid, 20 parts by weight of stearic acid, 20 parts by weight of behenic acid, 30 parts by weight of lignoceric acid, 5 parts by weight of palmitic alcohol, 5 parts by weight of stearic alcohol, 5 parts by weight of arachidyl alcohol and 5 parts by weight of lignoceric alcohol, operate as well as the adjustment of the ester wax (A), prepare a comparative ester (F) having 32-52 carbons and is that the ester compound having the maximum number of carbons content of 25.4% of the total wax in the way the ester wax (A) is prepared. Data of the comparative ester WAX (F) is shown in the following table 1.

Preparation of Comparative Ester Wax (G)

In addition add 20 parts by weight of palmitic acid, 30 parts by weight of stearic acid, 30 parts by weight of lignoceric acid, 15 parts by weight of palmitic alcohol and 5 parts by weight of lignoceric alcohol, operate as well as the adjustment of the ester wax (A), prepare a comparative ester (G) having 34-48 carbons and is that the ester compound having the maximum number of carbons content of 19.1% of the total wax in the way the ester wax (A) is prepared. Data of the comparative ester WAX (G) is shown in the following table 1.

TABLE 1

| | CARBON NUMBER AND CONTENT OF ALKYL GROUP IN WAX(WEIGHT %) | | | | | | | | | | | | |
|---|---|---|---|---|---|---|---|---|---|---|---|---|---|
| | CARBON NUMBER | 30 | 32 | 34 | 36 | 38 | 40 | 42 | 44 | 46 | 48 | 50 | 52 |
| ESTER | A | 0.0 | 0.0 | 0.0 | 2.3 | 3.1 | 18.8 | 31.4 | 35.3 | 3.7 | 5.4 | 0.0 | 0.0 |
| WAX | B | 0.0 | 0.0 | 0.0 | 0.0 | 2.5 | 18.5 | 16.2 | 44.5 | 18.3 | 0.0 | 0.0 | 0.0 |
| | C | 0.0 | 1.4 | 2.5 | 6.0 | 8.0 | 21.9 | 20.5 | 19.3 | 15.0 | 5.4 | 0.0 | 0.0 |
| | D | 0.0 | 0.0 | 0.0 | 0.5 | 6.5 | 16.4 | 46.2 | 28.5 | 1.9 | 0.0 | 0.0 | 0.0 |
| | E | 0.0 | 0.0 | 2.1 | 3.2 | 19.1 | 18.5 | 17.9 | 16.5 | 15.3 | 7.4 | 0.0 | 0.0 |
| | F | 0.0 | 1.1 | 2.1 | 6.3 | 13.2 | 25.4 | 21.9 | 16.5 | 6.4 | 3.5 | 2.1 | 1.5 |
| | G | 2.8 | 5.3 | 7.3 | 9.6 | 15.3 | 14.2 | 13.7 | 11.9 | 9.5 | 6.9 | 3.5 | 0.0 |

Preparation of Crystalline Polyester

Add 1300 parts of 1,6-hexanediol, 1300 parts of fumaric acid, 1 part of hydroquinone and 10 parts of 2-ethylhexanoic acid tin (II) in four 5 L flasks in which a nitrogen guide tube, a dewatering tube, a stirrer and a thermoelectric couple are configured, react the mixture for 5 h at 160 degree Celsius, heat the mixture to 200 degree Celsius, react the mixture for 3 h, and react the mixture for 1 h at a pressure of 8.3 kPa.

In addition, the melting point of the obtained crystalline polyester is measured by DSC ‘DSC Q2000’ (produced by TA Instrument Corporation). The measurement is carried out in the following way: 5 mg sample is covered by a cover or pan of alumina and heated at a heating rate of 10 degree Celsius/min in a measurement temperature of 20˜200 degree Celsius; then the sample heated to 200 degree Celsius is cooled to be lower than 20 degree Celsius, and then heated again. The result resulting from the measurement above is taken as data, and the maximum heat absorption peak generated at about 80 degree Celsius to about 120 degree Celsius is taken as the melting point of the crystalline polyester resin. The melting point of the crystalline polyester (a) is 102 degree Celsius.

By adjusting the amount of hydroquinone, reaction time and reaction temperature, a crystalline polyester (b) having a melting point of 91 degree Celsius, a crystalline polyester (c) having a melting point of 108 degree Celsius, a comparative crystalline polyester (d) having a melting point of 88 degree Celsius and a crystalline polyester (e) having a melting point of 114 degree Celsius can be obtained.

Preparation of Toner Mother Particle 1

| | |
|---|---|
| Polyester resin (binder) | 80 parts by weight |
| Crystalline, polyester resin (a) | 10 parts by weight |
| Ester wax (A) | 3 parts by weight |
| Coloring agent Carbon black MA-100 (Produced | 6 parts by weight |
| by Mitsubishi Chemical Corporation) | |
| Charge control agent (polysaccharide | 1 part by weight |
| compound containing Al and Mg) | |

The materials above are mixed using a Henschel mixer and then melted and kneaded using a 120 degree Celsius two-screw kneader to obtain a kneaded material.

The obtained kneaded material is coarsely pulverized using a feather mill and then pulverized using a jet mill, sequentially, the pulverized material is classified using a rotor type classifier to obtain toner mother particle 1 having a volume average particle size of 5.8 μm.

Preparation of Toner Mother Particle 2

| | |
|---|---|
| Polyester resin (binder) | 80 parts by weight |
| Crystalline polyester resin (a) | 10 parts by weight |
| Ester wax (C) | 3 parts by weight |
| Coloring agent (MA-100) | 6 parts by weight |
| Charge control agent (polysaccharide | 1 part by weight |
| compound containing Al and Mg) | |

The toner mother particle 2 having a volume average particle size of 6.1 μm is prepared with the materials above in the way the toner mother particle 1 is prepared.

Preparation of Toner Mother Particle 3

| | |
|---|---|
| Polyester resin (binder) | 80 parts by weight |
| Crystalline polyester resin (a) | 10 parts by weight |
| Ester wax (B) | 3 parts by weight |
| Coloring agent (MA-100) | 6 parts by weight |
| Charge control agent (polysaccharide | 1 part by weight |
| compound containing Al and Mg) | |

The toner mother particle 3 having a volume average particle size of 6.0 μm is prepared with the materials above in the way the toner mother particle 1 is prepared.

Preparation of Toner Mother Particle 4

| | |
|---|---|
| Polyester resin (binder) | 80 parts by weight |
| Crystalline polyester (b) | 10 parts by weight |
| Ester wax (A) | 3 parts by weight |
| Coloring agent (MA-100) | 6 parts by weight |
| Charge control agent (polysaccharide | 1 part by weight |
| compound containing Al and Mg) | |

The toner mother particle 4 having a volume average particle size of 6.3 μm is prepared with the materials above in the way the toner mother particle 1 is prepared.

Preparation of Toner Mother Particle 5

| | |
|---|---|
| Polyester resin (binder) | 80 parts by weight |
| Crystalline polyester (c) | 10 parts by weight |
| Ester wax (A) | 3 parts by weight |
| Coloring agent (MA-100) | 6 parts by weight |
| Charge control agent (polysaccharide | 1 part by weight |
| compound containing Al and Mg) | |

The toner mother particle 5 having a volume average particle size of 6.5 μm is prepared with the materials above in the way the toner mother particle 1 is prepared.

Preparation of Comparative Toner Mother Particle 1

| | |
|---|---|
| Polyester resin (binder) | 80 parts by weight |
| Crystalline polyester resin (a) | 10 parts by weight |
| Comparative ester wax (D) | 3 parts by weight |
| Coloring agent (MA-100) | 6 parts by weight |
| Charge control agent (polysaccharide | 1 part by weight |
| compound containing Al and Mg) | |

The comparative toner mother particle 1 having a volume average particle size of 6.0 μm is prepared with the materials above in the way the toner mother particle 1 is prepared.

Preparation of Comparative Toner Mother Particle 2

| | |
|---|---|
| Polyester resin (binder) | 80 parts by weight |
| Crystalline polyester resin (a) | 10 parts by weight |
| Comparative ester wax (E) | 3 parts by weight |
| Coloring agent (MA-100) | 6 parts by weight |
| Charge control agent (polysaccharide | 1 part by weight |
| compound containing Al and Mg) | |

The comparative toner mother particle 2 having a volume average particle size of 6.4 μm is prepared with the materials above in the way the toner mother particle 1 is prepared.

Preparation of Comparative Toner Mother Particle 3

| | |
|---|---|
| Polyester resin (binder) | 80 parts by weight |
| Crystalline polyester resin (d) | 10 parts by weight |
| Comparative ester wax (A) | 3 parts by weight |
| Coloring agent (MA-100) | 6 parts by weight |
| Charge control agent (polysaccharide | 1 part by weight |
| compound containing Al and Mg) | |

The comparative toner mother particle 3 having a volume average particle size of 6.1 μm is prepared with the materials above in the way the toner mother particle 1 is prepared.

Preparation of Comparative Toner Mother Particle 4

| | |
|---|---|
| Polyester resin (binder) | 80 parts by weight |
| Crystalline polyester resin (e) | 10 parts by weight |
| Comparative ester wax (A) | 3 parts by weight |
| Coloring agent (MA-100) | 6 parts by weight |
| Charge control agent (polysaccharide | 1 part by weight |
| compound containing Al and Mg) | |

The comparative toner mother particle 4 having a volume average particle size of 5.7 μm is prepared with the materials above in the way the toner mother particle 1 is prepared.

Preparation of Comparative Toner Mother Particle 5

| | |
|---|---|
| Polyester resin (binder) | 80 parts by weight |
| Crystalline polyester resin (e) | 10 parts by weight |
| Comparative ester wax (D) | 3 parts by weight |
| Coloring agent (MA-100) | 6 parts by weight |
| Charge control agent (polysaccharide | 1 part by weight |
| compound containing Al and Mg) | |

The comparative toner mother particle 5 having a volume average particle size of 5.8 μm is prepared with the materials above in the way the toner mother particle 1 is prepared.

Preparation of Comparative Toner Mother Particle 6

| | |
|---|---|
| Polyester resin (binder) | 80 parts by weight |
| Crystalline polyester resin (a) | 10 parts by weight |
| Comparative ester wax (E) | 3 parts by weight |
| Coloring agent (MA-100) | 6 parts by weight |
| Charge control agent (polysaccharide | 1 part by weight |
| compound containing Al and Mg) | |

The comparative toner mother particle 6 having a volume average particle size of 5.5 μm is prepared with the materials above in the way the toner mother particle 1 is prepared.

Preparation of Comparative Toner Mother Particle 7

| | |
|---|---|
| Polyester resin (binder) | 80 parts by weight |
| Crystalline polyester resin (e) | 10 parts by weight |
| Comparative ester wax (F) | 3 parts by weight |
| Coloring agent (MA-100) | 6 parts by weight |
| Charge control agent (polysaccharide | 1 part by weight |
| compound containing Al and Mg) | |

The comparative toner mother particle 7 having a volume average particle size of 6.2 μm is prepared with the materials above in the way the toner mother particle 1 is prepared.

### Example 1

1.0% by weight of silica particle (TGC-413-50 nm: produced by Cabot Corporation) prepared using the sol-gel method, 1.3% by weight of fumed silica particle and 0.9% by weight of titanium oxide particles are added into the toner mother particle 1 and then mixed using a Henschel mixer, then, sifted by an ultrasonic vibration to obtain the toner involved in example 1.

A developer is made by mixing with a ratio of 6 parts by weight of the obtained toner to 100 parts by weight of a ferrite carrier which is coated by silicone resin having a volume average particle size of 40 μm using a Tabura mixer.

The obtained developer is subjected to evaluations on low-temperature fixation property, toner scattering level and toner fogging (long life), and the results of the evaluations are recorded in the following Table 2.

Low-Temperature Fixation Property

10 solid images are obtained by setting the fixing temperature to be 130 degree Celsius by modifying an e-studio2050c (produced by Toshiba Tec Co., Ltd) fixing system adopting a DC development method. Although 10 solid images is few, low-temperature fixation property is marked as o if there is no image shedding caused by an offset or non-fixation or x if there is image shedding caused by an offset or non-fixation.

Toner Scattering Level and Fogging (Long Life)

After an original having a printing rate of 8.0% is continuously copied onto A4 papers for 200 times in a low-temperature low-humidity environment using e-STUDIO2050c (produced by Toshiba Tec Co., Ltd) fixing system adopting a DC development method, solid images are acquired and copied for 100000 times, sequentially, the solid images are acquired and copied onto A4 papers for 100000 times in a high-temperature high-humidity environment to obtain solid images. Then, the scattering level of the toner is marked as 0 if no toner is dropped on an image due to the scattering of the toner or X if a paper is stained by toner drops due to the scattering or fogging of the toner.

Additionally, the solid images obtained in different environments are vivid images.

Storability

20 g toner is sealed in a plastic container, then, the plastic container is placed in a 55 degree Celsius thermostatic bath for 10 h. After the toner is taken out from the thermostatic bath, the toner is cooled naturally for more than 12 h, the toner placed on a 42-mesh screen is placed on a powder tester (produced by Hosokawa Micron Corporation), then, sets a scale for 4 and sifts the toner for 10 seconds, then, the storability of the toner is marked as O if the amount of the toner left is 0-3 g or the storability of the toner is marked as X if the amount of the toner left is above 3 g.

The obtained toner is applied to a laser printer using a DC development method to form an image having high image quality.

### Example 2

0.2% by weight of silica particles (TGC-443-50 nm: produced by Cabot Corporation) prepared using the sol-gel method, 1.5% by weight of fumed silica particles and 0.7% by weight of titanium oxide particles are added into the toner mother particles 1 and then mixed using a Henschel mixer, then, the mixture is screened using an ultrasonic vibrating screen to obtain the toner involved in example 2.

### Example 3

1.9% by weight of silica particles (TGC-390-65 nm: produced by Cabot Corporation) prepared using the sol-gel method, 1.1% by weight of fumed silica particles and 0.7% by weight of titanium oxide particles are added into the toner mother particles 1 and then mixed using a Henschel mixer, then, the mixture is screened using an ultrasonic vibrating screen to obtain the toner involved in example 3.

### Example 4

1.0% by weight of Silica particles (TGC-413-50 nm: produced by Cabot Corporation) prepared using the sol-gel method, 1.3% by weight of fumed silica particles and 0.9% by weight of titanium oxide particles are added into the toner mother particles 2 and then mixed using a Henschel mixer, then, the mixture is screened using an ultrasonic vibrating screen to obtain the toner involved in example 4.

### Example 5

1.0% by weight of silica particles (TGC-443-50 nm: produced by Cabot Corporation) prepared using the sol-gel method, 1.3% by weight of fumed silica particles and 0.9% by weight of titanium oxide particles are added into the toner mother particles 3 and then mixed using a Henschel mixer, then, the mixture is screened using an ultrasonic vibrating screen to obtain the toner involved in example 5.

### Example 6

1.0% by weight of silica particles (TGC-390-65 nm: produced by Cabot Corporation) prepared using the sol-gel method, 1.3% by weight of fumed silica particles and 0.9% by weight of titanium oxide particles are added into the toner mother particles 4 and then mixed using a Henschel mixer, then, the mixture is screened using an ultrasonic vibrating screen to obtain the toner involved in example 6.

### Example 7

1.0% by weight of silica particles (TGC-243-85 nm: produced by Cabot Corporation) prepared using the sol-gel method, 1.3% by weight of fumed silica particles and 0.9% by weight of titanium oxide particles are added into the toner mother particles 5 and then mixed using a Henschel mixer, then, the mixture is screened using an ultrasonic vibrating screen to obtain the toner involved in example 7.

### Comparative Example 1

0.1% by weight of silica particles (TGC-413-50 nm: produced by Cabot Corporation) prepared using the sol-gel method, 1.5% by weight of fumed silica particles and 0.9% by weight of titanium oxide particles are added into the toner mother particles 1 and then mixed using a Henschel mixer, then, the mixture is screened using an ultrasonic vibrating screen to obtain the toner involved in comparative example 1.

### Comparative Example 2

2.0% by weight of Silica particles (TGC-443-50 nm: produced by Cabot Corporation) prepared using the sol-gel method, 0.9% by weight of fumed silica particles and 0.9% by weight of titanium oxide particles are added into the toner mother particles 1 and then mixed using a Henschel mixer, then, the mixture is screened using an ultrasonic vibrating screen to obtain the toner involved in comparative example 2.

### Comparative Example 3

1.0% by weight of Silica particles (TGC-443-50 nm: produced by Cabot Corporation) prepared using the sol-gel method, 1.3% by weight of fumed silica particles and 0.9% by weight of titanium oxide particles are added into the comparative toner particles 1 and then mixed using a Henschel mixer, then, the mixture is screened using an ultrasonic vibrating screen to obtain the toner involved in comparative example 3.

### Comparative Example 4

1.0% by weight of Silica particles (TGC-390-65 nm: produced by Cabot Corporation) prepared using the sol-gel method, 1.3% by weight of fumed silica particles and 0.9% by weight of titanium oxide particles are added into the comparative toner particles 2 and then mixed using a Henschel mixer, then, the mixture is screened using an ultrasonic vibrating screen to obtain the toner involved in comparative example 4.

### Comparative Example 5

1.0% by weight of silica particles (TGC-413-50 nm: produced by Cabot Corporation) prepared using the sol-gel method, 1.5% by weight of fumed silica particles and 0.9% by weight of titanium oxide particles are added into the comparative toner particles 3 and then mixed using a Henschel mixer, then, the mixture is screened using an ultrasonic vibrating screen to obtain the toner involved in comparative example 5.

### Comparative Example 6

1.0% by weight of Silica particles (TGC-443-50 nm: produced by Cabot Corporation) prepared using the sol-gel method, 1.5% by weight of fumed silica particles and 0.9% by weight of titanium oxide particles are added into the comparative toner particles 4 and then mixed using a Henschel mixer, then, the mixture is screened using an ultrasonic vibrating screen to obtain the toner involved in comparative example 6.

### Comparative Example 7

0.1% by weight of Silica particles (TGC-413-50 nm: produced by Cabot Corporation) prepared using the sol-gel method, 1.8% by weight of fumed silica particles and 0.9% by weight of titanium oxide particles are added into the comparative toner particles 4 and then mixed using a Henschel mixer, then, the mixture is screened using an ultrasonic vibrating screen to obtain the toner involved in comparative example 7.

### Comparative Example 8

0.1% by weight of Silica particles (X-24-9163A-110 nm: produced by Shin-Etsu Chemical Corporation) prepared using the sol-gel method, 1.5% by weight of fumed silica particles and 0.9% by weight of titanium oxide particles are added into the toner mother particles 1 and then mixed using a Henschel mixer, then, the mixture is screened using an ultrasonic vibrating screen to obtain the toner involved in comparative example 8.

### Comparative Example 9

0.1% by weight of Silica particles (TGC190-115 nm: produced by Cabot Corporation) prepared using the sol-gel method, 1.5% by weight of fumed silica particles and 0.9% by weight of titanium oxide particles are added into the toner mother particles 1 and then mixed using a Henschel mixer, then, the mixture is screened using an ultrasonic vibrating screen to obtain the toner involved in comparative example 9.

### Comparative Example 10

1.0% by weight of silica particles ((TGC-413-50 nm: produced by Cabot Corporation) prepared using the sol-gel method, 1.3% by weight of fumed silica particles and 0.9% by weight of titanium oxide particles are added into the comparative toner particles 6 and then mixed using a Henschel mixer, then, the mixture is screened using an ultrasonic vibrating screen to obtain the toner involved in comparative example 10.

### Comparative Example 11

1.0% by weight of silica particles (TGC-443-50 nm: produced by Cabot Corporation) prepared using the sol-gel method, 1.3% by weight of fumed silica particles and 0.9% by weight of titanium oxide particles are added into the comparative toner particles 7 and then mixed using a Henschel mixer, then, the mixture is screened using an ultrasonic vibrating screen to obtain the toner involved in comparative example 10.

Examples 2-7 and comparative examples 1-11 are evaluated as example 1 and the results of the evaluations are recorded in Table 2.

TABLE 2
A

| | ADDITION | PARTICLE | | | | | | |
|---|---|---|---|---|---|---|---|---|
| | AMOUNT | SIZE OF | ESTER WAX | | | | | |
| | OF SILICA | SILICA | | RATIO OF | | | | |
| | PARTICLE | PARTICLE | | CARBON | | | | |
| | PREPARED | PREPARED | | NUMBER | METING | LOW- | | |
| | BY | BY | RANGE | REPRESENTING | POINT OF | TEMPER- | TONER | |
| | SOL-GEL | SOL-GEL | OF | MAXIMUM | CRYSTALLINE | ATURE | SCATTERING | |
| | METHOD | METHOD | CARBON | STRENGTH | POLYESTER | FIXATION | AND | |
| | (WEIGHT %) | (nm) | NUMBER | (WEIGHT %) | (□) | PROPERTY | FOGGING | STORABILITY |
| EXAMPLE 1 | 1.0 | 50 | 36-48 | 35.3 | 102 | ◯ | ◯ | ◯ |
| EXAMPLE 2 | 0.2 | 50 | 36-48 | 35.3 | 102 | ◯ | ◯ | ◯ |
| EXAMPLE 3 | 1.9 | 65 | 36-48 | 35.3 | 102 | ◯ | ◯ | ◯ |
| EXAMPLE 4 | 1.0 | 50 | 32-48 | 21.9 | 102 | ◯ | ◯ | ◯ |
| EXAMPLE 5 | 1.0 | 50 | 38-46 | 44.5 | 102 | ◯ | ◯ | ◯ |
| EXAMPLE 6 | 1.0 | 65 | 36-48 | 35.3 | 91 | ◯ | ◯ | ◯ |
| EXAMPLE 7 | 1.0 | 85 | 36-48 | 35.3 | 108 | ◯ | ◯ | ◯ |
| COMPARATIVE | 0.1 | 50 | 36-48 | 35.3 | 102 | ◯ | X | ◯ |
| EXAMPLE 1 | | | | | | | | |
| COMPARATIVE | 2.0 | 50 | 36-48 | 35.3 | 102 | ◯ | ◯ | X |
| EXAMPLE 2 | | | | | | | | |
| COMPARATIVE | 1.0 | 50 | 34-48 | 19.1 | 102 | ◯ | ◯ | X |
| EXAMPLE 3 | | | | | | | | |
| COMPARATIVE | 1.0 | 65 | 38-46 | 46.2 | 102 | X | ◯ | ◯ |
| EXAMPLE 4 | | | | | | | | |
| COMPARATIVE | 1.0 | 50 | 36-48 | 35.3 | 88 | ◯ | ◯ | X |
| EXAMPLE 5 | | | | | | | | |
| COMPARATIVE | 1.0 | 50 | 36-48 | 35.3 | 114 | X | ◯ | X |
| EXAMPLE 6 | | | | | | | | |
| COMPARATIVE | 0.1 | 50 | 34-48 | 19.1 | 114 | X | X | X |
| EXAMPLE 7 | | | | | | | | |
| COMPARATIVE | 1.0 | 110 | 36-48 | 35.3 | 102 | ◯ | X | X |
| EXAMPLE 8 | | | | | | | | |
| COMPARATIVE | 1.0 | 115 | 36-48 | 35.3 | 102 | ◯ | X | X |
| EXAMPLE 9 | | | | | | | | |
| COMPARATIVE | 1.0 | 50 | 32-52 | 19.1 | 114 | X | ◯ | ◯ |
| EXAMPLE 10 | | | | | | | | |
| COMPARATIVE | 1.0 | 50 | 30-50 | 19.1 | 114 | ◯ | ◯ | X |
| EXAMPLE 11 | | | | | | | | |

As shown in Table 2, in examples 1-7, the results of the evaluations on low-temperature fixation property, the scattering and fogging and the storability of the toner are good, while in comparative examples 1-11, there was a problem with one or more of these evaluations.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A developer including a toner, wherein
the toner includes:
a binder resin;
a coloring material;
a crystalline polyester resin having a peak DSC melting point of higher than 90 degree Celsius but lower than 110 degree Celsius;
a toner core particle including an ester wax having a liner alky having 15-48 carbons and containing an ester compound of the carbon number of which represents the maximum strength in mass spectrometer content of more than 20 weight percent but smaller than 45 percent of the total weight of all of the ester wax; and
a silica particle having a volume average particle size of smaller than 85 nm combined by a sol-gel method and added on the surface of the toner core particles as an additive, wherein
the toner with the silica particle content of 0.2-2.0 weight percent.

2. The developer according to claim 1, wherein the binder resin is an amorphous polyester resin.

3. The developer according to claim 1, wherein the silica particle combined by the sol-gel method has a volume average particle size of 50-85 nm.

4. The developer according to claim 1, wherein the carbon number of the ester compound representing the maximum strength in a mass spectrometry is 38-45.

5. The developer according to claim 1, wherein the additive further contains melted silica particles and titanium oxide.

6. The developer according to claim 1, wherein the melted silica particles and the titanium oxides have a volume average particle size of 7-150 nm, and the addition amount of the melted silica particles and the titanium oxides is 1.5-7 weight percent by weight with respect to the total weight of the toner.

7. The developer according to claim 1, wherein the content of the crystalline polyester resin is 3-10 weight percent by weight with respect to 100 weight percent by weight of the binder resin.

8. The developer according to claim 1, wherein the content of the ester wax is 3-10 weight percent by weight with respect to 100 weight percent by weight of the binder resin.

9. The developer according to claim 1, wherein the total content of the crystalline polyester resin and the ester wax is 6-20 weight percent by weight with respect to 100 weight percent by weight of the binder resin.

10. A toner cartridge for housing a developer including a toner, wherein
the toner includes:
a binder resin;
a coloring material;
a crystalline polyester resin having a peak DSC melting point of higher than 90 degree Celsius but lower than 110 degree Celsius;
a toner core particle including an ester wax having a liner alky having 15-48 carbons and containing an ester compound of the carbon number of which represents the maximum strength in mass spectrometer content of more than 20 weight percent but smaller than 45 percent of the total weight of all of the ester wax; and
a silica particle having a volume average particle size of smaller than 85 nm combined by a sol-gel method and added on the surface of the toner core particles as an additive, wherein
the toner with the silica particle content of 0.2-2.0 weight percent.

11. The toner cartridge according to claim 10, wherein the binder resin is an amorphous polyester resin.

12. The toner cartridge according to claim 10, wherein the silica particle combined by the sol-gel method has a volume average particle size of 50-85 nm.

13. The toner cartridge according to claim 10, wherein the carbon number of the ester compound representing the maximum strength in mass spectrometry is 38-45.

14. The toner cartridge according to claim 10, wherein the additive further contains melted silica particle and titanium oxide.

15. The toner cartridge according to claim 14, wherein the melted silica particles and the titanium oxides have a volume average particle size of 7-150 nm, and the addition amount of the melted silica particles and the titanium oxide is 1.5-7 weight percent by weight with respect to the total weight of the toner.

16. The developer according to claim 1, wherein the content of the crystalline polyester resin is 3-10 weight percent by weight with respect to 100 weight percent by weight of the binder resin.

17. The toner cartridge according to claim 10, wherein the content of the ester wax is 3-10 weight percent by weight with respect to 100 weight percent by weight of the binder resin.

18. The toner cartridge according to claim 10, wherein the total content of the crystalline polyester resin and the ester wax is 6-20 weight percent by weight with respect to 100 weight percent by weight of the binder resin.
